(19) United States
(12) Patent Application Publication
(10) Pub. No.: US 2023/0243660 A1
(43) Pub. Date: Aug. 3, 2023

(54) Intelligently presenting routing options using historical and predictive data

(71) Applicant: Ontario Zeng, Temecula, CA (US)

(72) Inventor: Ontario Zeng, Temecula, CA (US)

(21) Appl. No.: 17/588,738

(22) Filed: Jan. 31, 2022

(51) Int. Cl. G01C 21/34; G01C 21/36

(52) U.S. Cl. CPC G01C 21/3415; G01C 21/3492; G01C 21/367; G01C 21/3676

(57) ABSTRACT

This invention relates to intelligently presenting the estimated travel time of a vehicle/driver to its desired destination. Instead of using the current speed/time on different segments of the route that a vehicle will travel at a later time, the invention predicts estimated driving time by using historical traffic information from similar times of the day, and days of the week, taking into account holidays and, impacts on traffic from similar accidents or nearby events, as well as road/lane open/closed status. The result is a more accurate estimation of travel time along segments that follow predictable traffic patterns and giving a driver more information to pick which route to take.

### FIELD OF THE INVENTION

This invention relates to intelligently presenting the estimated travel time of a vehicle/driver to its desired destination. Instead of using the current speed/time on different segments of the route that a vehicle will travel at a later time, the invention predicts estimated driving time by using historical traffic information from similar times of the day, and days of the week, taking into account holidays and, impacts on traffic from similar accidents or nearby events, as well as road/lane open/closed status. The result is a more accurate estimation of travel time along segments that follow predictable traffic patterns and giving a driver more information to pick which route to take.

### BACKGROUND

Identifying the shortest or fastest route using technologies such as GPS is an integral part of our modern lives. Once a starting point and destination have been identified, a routing system will present several options with different distances and estimated travel times for a user to choose from. The total distance as well as the estimated travel time for each option is the sum of these figures of all the segments comprising this option.

However, the estimated travel time of each segment is the current travel time if this vehicle were traveling that segment at the time of calculation. It is not the estimated travel time when this vehicle finally arrives at the starting point of this segment. When a route is long or complicated, the estimated travel time based on a vehicle currently travelling this segment and the time when the vehicle is actually ready to take said segment can be significantly different. These are some examples that could lead to significant differences:
Traffic on a segment in the middle of a vehicle's route is light. Traffic will become congested beginning 4 PM on weekdays due to commuters leaving for their homes. A vehicle will start the route at 1 μm and is projected to reach this segment at 4 pm.
Traffic on a segment in the middle of a vehicle's route is light. A concert or sporting event will start 5 pm. Traffic will pick up starting at 4 pm with fans arriving. A vehicle will start the route at 1 μm and is projected to reach this segment at 4 pm.
It's 1 PM. Traffic is abnormally heavy due to a road incident at a segment in the middle of a vehicle's route. The incident is expected to be solved within an hour. Traffic will back to normal light condition by 3 pm. A vehicle will start the route at 1 μm and is projected to reach this segment at 4 pm.
Traffic on a segment in the middle of a vehicle's route is light. One lane on this segment will be closed at 3 pm. Traffic is expected to pick up after that. A vehicle will start the route at 1 pm and is projected to reach this segment at 4 pm.

Therefore, a need exists for a routing algorithm that provides the estimated travel time of a road segment based on the traffic condition at the time when a vehicle will reached the segment, not at the moment when the overall trip was initially routed. This will provide a more accurately estimated travel time for each route and allow a driver to make an informed decision.

### DESCRIPTION OF THE DRAWINGS

Some travel scenarios where the present invention provides more accurate travel times are illustrated in the two figures of the accompanying drawings.

FIG. 1—FIG. 1 depicts a hypothetical scenario where one route looks promising initially but turns out to take longer later. When the route was initially planned at 4 pm by using the current traffic speed on all segments, route option #1 (60 minutes=5+30+20+5 minutes) takes less time than route option #2 does (80 minutes=5+40+30+5 minutes). However, when a vehicle is almost ready to start the trip on segment C1 at 4:30 pm, due to people started leaving offices for their homes, C1 is much more congested. As a result, the trip along route option #1 will take much longer (100 minutes=5+30+60+5 minutes). On the other hand, a trip along route option #2 still takes 80 minutes. If a routing system can accurately include the expected daily recurring traffic jam along segment C1 in its estimation, a driver will be in a better position to decide whether route option #1 or #2 should be selected.

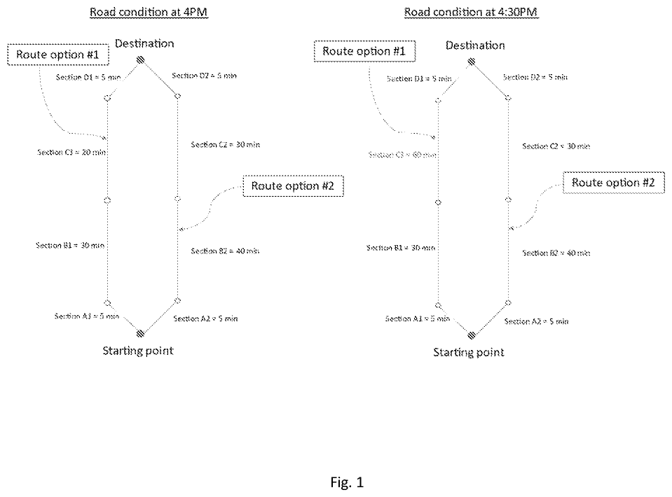

FIG. 2-FIG. 2 depicts another hypothetical scenario where one route is not available at the time of route planning. When the route was initially planned at 11:30 m, segment C2 was closed so option #2 wouldn't be listed as an option. However, when a vehicle reaches the end of B2 at 12:05 pm, C2 will have been opened. As a result, option #2 will have allowed the vehicle to reach the destination sooner. If routing systems can accurately include the expected lane/road closure/opening on segment C2 in their estimations, a driver will be in a better position to decide whether route option #1 or #2 should be selected.

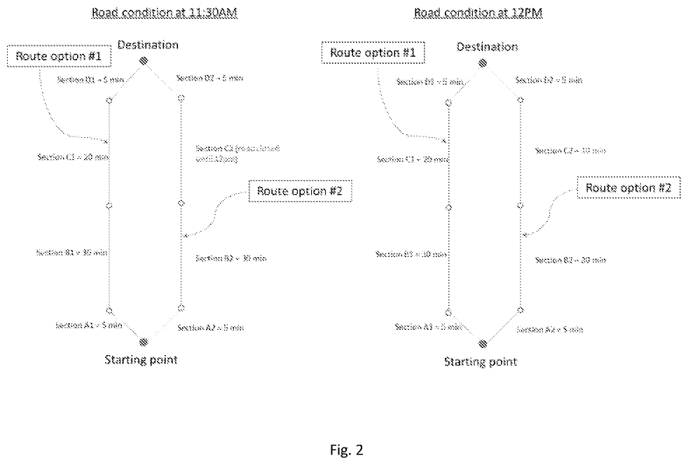

### DESCRIPTION OF THE INVENTION

The present invention devises a novel method to estimate the required travel time for each road segment at different starting times. As a result, more accurate travel time estimations will be presented to the driver/vehicle. To build historical knowledge of the estimated traffic condition for a road segment at different times of the day during different days of the week, the routing system needs to accumulate the following data for this road segment:
Travel time for this segment during workday at different time of the day at certain intervals, i.e., every 15 minutes. This interval might be shorter during peak hours and longer off-peak hours.
Travel time for this segment during weekend and holidays at different time of the day at certain intervals, i.e., every 15 minutes. This interval might be shorter during peak hours.
If applicable, travel time for this segment at certain intervals, i.e., 15 or 30 minutes before or after a nearby major event (sports or a concert).

Additionally, knowledge should be built for traffic accident resolution time in different categories, for example, single vehicle accidents, two-vehicle accidents, 3+ vehicle accidents, 10+ vehicle accidents, etc. Additionally, the system needs to build knowledge about how traffic speed correlates to accident resolution time. Lane/road closures with time/date information from the Department of Transportation will also be reflected in the calculation.

Once the above-mentioned historical data have been acquired, the process to estimate travel time for a route is broken down into following steps:
Break a route into multiple segments, through different roads, and/or different average speeds of different parts of the same road
Current time is defined as TO
Calculate the estimated travel time for the first segment (T1) using the current traffic information

$$T 1 = \frac{length of segment 1}{t r affic speed of segment 1 at T 0}$$

The process to calculate the estimated travel time for the second segment (T2) is as follows:
   Is there a big event nearby that overlaps with the estimated starting time (T0+T1) and the initial estimated end time (T0+T1+T2_now) for the second segment? If yes, record the estimated travel time impact based on historical data (T2_event)
   Is there a lane closure/opening event that overlaps with the estimated starting time (T0+T1) and the initial estimated end time (T0+T1+T2_now) for the second segment? If yes, record the estimated travel time impact based on historical data (T2_lane closure/open)
   Is there a traffic accident that is impacting the speed for the second segment? If yes, record the estimated travel time impact based on historical data (T2_accident)
   Calculate the estimated travel time for the second segment using historical speed information (T2_historical) at T0+T1 moment

$$T2\_historical = \frac{lenght of segment 2}{historical traffic speed of segment 2 at ( T 0 + T 1 )}$$

The estimated travel time for the second segment (T2) is the sum of these factors: T2=T2_historical+T2_accident+T2_lane closure/open+T2_event
Repeat the above using the same methodology for all remaining segments, one segment at a time. Total estimated travel time is the sum of each segment's estimated time (T0+T1+ . . . +Tn)

The adjustment factors (Tn_accident, Tn_lane closure/open+Tn_event) will come from previously mentioned knowledge building process where how different event impacts a particular segment for how long is analyzed. For example, a sporting event may add 30 minutes to the traffic on a segment before and after the event's start time and end time, respectively, or a single car accident might add 30 minutes to the traffic on a segment and a two-car accident might add 45 minutes.

In order to provide faster responses and enable user flexibility, the routing system will allow a user to setup how they want these estimated travel times to be presented. For example:
1) If a trip is shorter than X miles, or Y minutes, only use the current traffic speed to present the estimated route time. X and Y are adjustable by users
2) If a trip's starting time and estimated finish time (by using the current speed) do not fall into typical traffic peak hours, only use the current traffic speed to present the estimated route time
3) Include or exclude traffic incident resolution time in the estimated route time

What is claimed is:

1. When a mapping or routing system presents a driver/vehicle with estimated travel time along a route, it should include the following information:
a. Using the historical traffic condition or travel time along different road segments, corresponding to the same workday, weekend, or holiday when a vehicle is expected to reach there as a reference to present a vehicle/driver with the most accurate information
b. Considering that a road/lane might change its open/close status when a vehicle is expected to reach that part of the road, even though that road/lane is currently open or closed
c. Considering that there is a big event nearby just might introduce a temporary traffic jam. Its beginning and ending might affect the traffic when a vehicle is expected to reach there
d. Considering that, although there is currently an incident impacting traffic, the traffic jam might intensify/disappear/shrink when a vehicle is expected to arrive

2. Estimated traffic time using the current traffic speed on each segment could be presented side-by-side with the estimated time using methodologies mentioned in the above paragraph. This is to help a user understand which and how assumption(s) based on historical statistics or transportation agency communications led to the difference, if there is a big difference between these two methods
